(19) United States
(12) Patent Application Publication
(10) Pub. No.: US 2004/0205674 A1
(43) Pub. Date: Oct. 14, 2004

(54) E-mail translation system and method

(76) Inventors: Maria Elena Delgado, San Diego, CA (US); Florentino Guizar, San Diego, CA (US); Tony S. Valenti, San Diego, CA (US)

Correspondence Address: PAUL, HASTINGS, JANOFSKY & WALKER LLP, P.O. BOX 919092, SAN DIEGO, CA, 92191-9092, US

(21) Appl. No.: 09/829,494

(22) Filed: Apr. 9, 2001

(51) Int. Cl. G09G 5/00

(52) U.S. Cl. 715/536; 345/752

(57) ABSTRACT

An embodiment of the present invention comprises a method of translating text in an e-mail message, comprising the steps of receiving original text in an original language in the e-mail message; translating the original text into translated text in a translated language; and displaying one or both of the original text and translated text in the e-mail message.

### BACKGROUND OF THE INVENTION

1. Field of the Invention

The present invention relates to a system and method for integrating electronic mail and text translation software.

2. Background

The Internet comprises a vast number of computers and computer networks that are interconnected through communication links. The interconnected computers can exchange information using various services, such as electronic mail (“e-mail”) and the World Wide Web (“WWW”). The WWW allows a server computer system (i.e., web server or web site) to send graphical web pages of information to a remote client (i.e., “user”) computer system. The remote client computer system can then display the web page. Each resource (e.g., computer or Web page) of the WWW is uniquely identifiable by a Uniform Resource Locator (“URL”). To view a specific web page, a client computer system specifies the URL for that web page in a request using a Hyper Text Transfer Protocol (“HTTP”). The request is forwarded to the web server that supports that web page. When that web server receives the request, it sends that web page to the client computer system. When the client computer system receives that web page, it typically displays the web page using a browser. A browser is a special-purpose application program that requests and displays the web pages on the personal computer.

Web pages are typically defined using Hyper Text Markup Language (“HTML”). HTML provides a standard set of tags that define how a web page is to be displayed. When a user indicates to the browser to display a web page, the browser sends a request to the server computer system to transfer to the client computer system an HTML document that defines the web page. The HTML document contains various tags that control the displaying of text, graphics, controls and other features. When the requested HTML document is received by the client computer system, the browser displays the web page as defined by the HTML document.

With an increasing internationalization of the Internet, there has been an increasing interest in translating text from one language to another via web sites on the Internet. One application of these translation methods relates to e-mail systems.

FIG. 1 shows a block diagram of a conventional e-mail translation system. In this example of a conventional e-mail translation system, a user's browser 2 is connected to an e-mail web server 6 via the Internet 10. Typically, the user's browser 2 resides on a personal computer, while the e-mail web server 6 resides at a facility that provides dedicated e-mail service. In this example, a recipient's browser 4 is also connected to the e-mail web server 6 via the Internet 10. Therefore, the e-mail web server 6 acts as a post office, such that when a user sends an e-mail request to the e-mail server 6, the e-mail web server 6 then sends (i.e., “delivers”) the e-mail to the recipient's mailbox (not shown in FIG. 1). The recipient's mailbox can be located on either the e-mail web server 6 or a different web server at a different web site (not shown in FIG. 1) The recipient of the e-mail can then access the sent e-mail through the recipient's browser 4, also typically located on a personal computer.

If the user wishes to translate an e-mail from one language into another language, the user must go through an involved four-step process requiring cutting and pasting to translate e-mail text. First, after the user displays a web page on the user's browser from the e-mail web server 6, the user writes text in the original language into an e-mail message. Second, the user must manually copy the text and paste the original text into a different web page from a translation web server 8. Third, after a text translation program on the translation web server 8 completes the translation and returns a new web page containing the translated text, the user must cut and paste the translated text back into the e-mail on the original web page. Finally, if the user modifies the original text after beginning the translation process (i.e., to create “new” original text), the user must modify or delete the “old” original text (and replace it with the “new” original text).

The conventional e-mail translation method shown in FIG. 1 has several inherent drawbacks. First, this process is cumbersome because the user must manually cut and paste blocks of text and transmit these blocks to a translation program. Further, the user is required to open a second instance of the browser to link to the translation web site. In addition, because the user might sometimes need to manually delete or modify the “old” original text and replace it with the “new” original text (such as when a user modifies the original text after beginning the translation routine), differences can result between the original text and the translated text.

One reason for these problems relates to the fact that the e-mail program and the text translation program work operate on entirely separate web servers. Because the text translation program and the e-mail software are accessible only via separate web servers, there is no integration of email and translation functionality. For example, when a user views an e-mail on a web page on the user's browser 2 and submits any type of query, the web page will return to the server from which it originated, i.e., the e-mail web server 6, because of the web page's HTML coding. The refreshed web page cannot be sent to an “outside” server, such as the translation web server 8, from either the user's browser 2 or the email web server 6. Therefore, the user cannot access the text translation program located on a separate server from within the e-mail application.

Further, conventional e-mail translation systems only offer a translation accuracy rate of approximately 68-72%. This relatively low accuracy rate occurs because conventional e-mail systems fail to provide language options unique to the specific translated language and instead rely on the user to provide modifications manually on a word by word basis.

Therefore, there is a need for an e-mail translation system and method that allows a user to create, translate and edit more accurate text for transmission within the e-mail environment.

### SUMMARY OF THE INVENTION

One embodiment of the present invention provides a method of translating text in an e-mail message, comprising the steps of receiving original text in an original language in the e-mail message; translating the original text into translated text in a translated language; and displaying one or both of the original text and translated text in the e-mail message. In an embodiment, the step of receiving the original text further comprises the step of providing one or more text modifications options.

In an embodiment, the one or more text modification options may comprise one or more options from the group comprising spell check, special language characteristics, direction of translation, gender selection, authorship number, formal or informal addressing and use of proper nouns.

### BRIEF DESCRIPTION OF THE DRAWINGS

The present invention will be described with particular embodiments thereof, and references will be made to the drawings in which:

FIG. 1 described above, is a block diagram of a conventional system for translating e-mail text from one language into another;

FIG. 2 is a block diagram illustrating an e-mail translation system in an embodiment of the present invention;

FIGS. 3A & 3B show a flow diagram of a e-mail translation system and method in an embodiment of the present invention;

FIG. 4 shows an e-mail form containing a window for entry of original text by a user, as output from one embodiment of the present invention;

FIG. 5 shows a translation form containing various language modification options, as output from one embodiment of the present invention;

FIG. 6 shows a translation form containing various language modification options, as output from one embodiment of the present invention;

FIG. 7 shows an e-mail form with a window containing both the original text and the translated text, as output from one embodiment of the present invention; and

FIG. 8 shows a received e-mail message containing the original text and the translated text, as output from one embodiment of the present invention.

### DETAILED DESCRIPTION

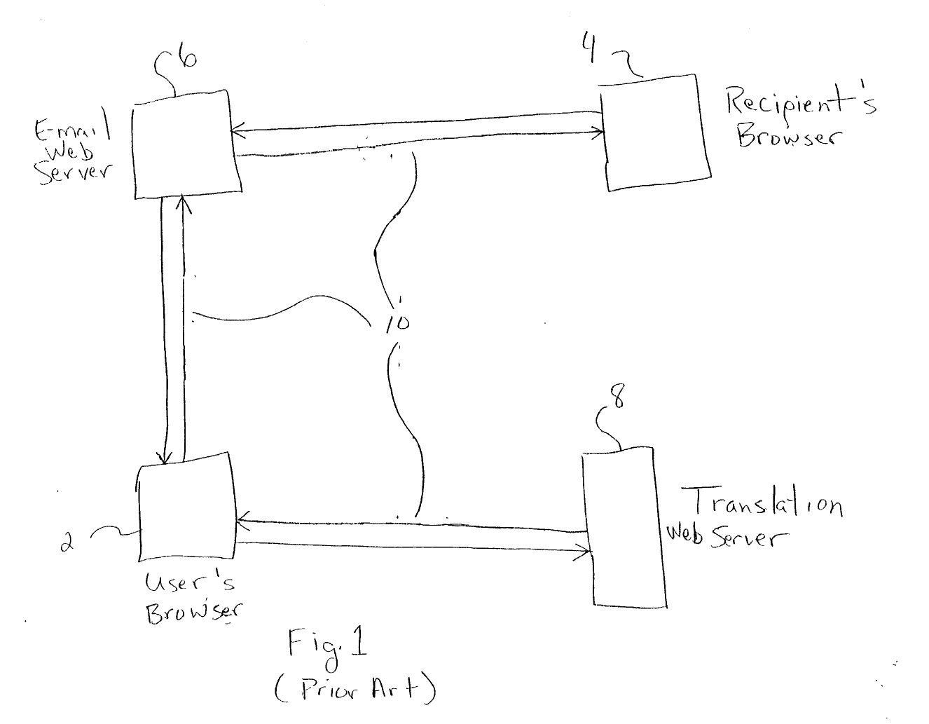

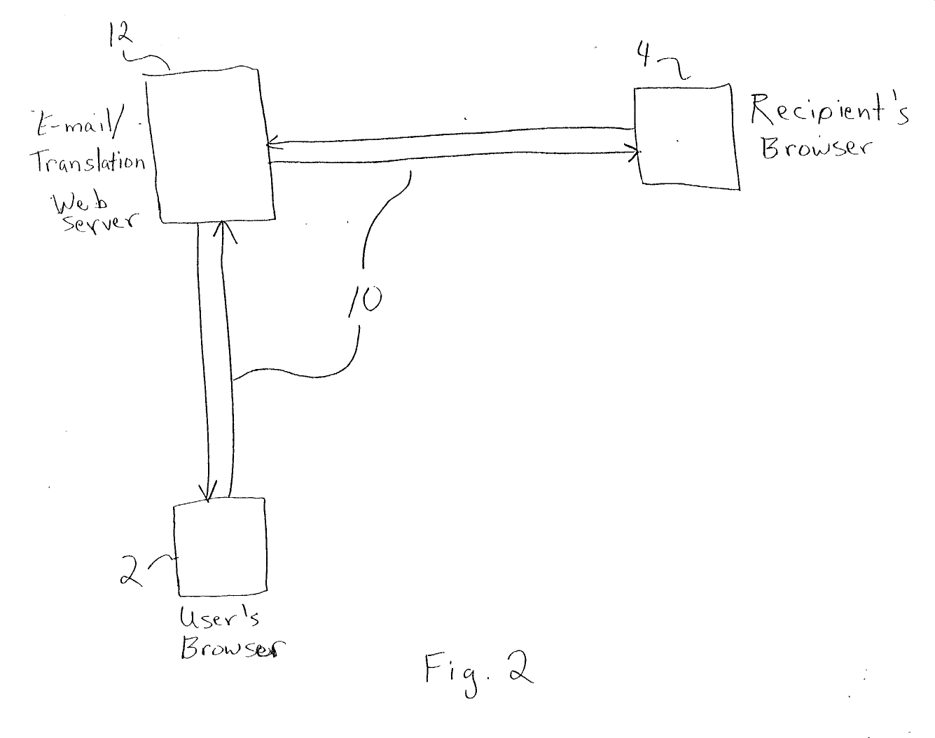

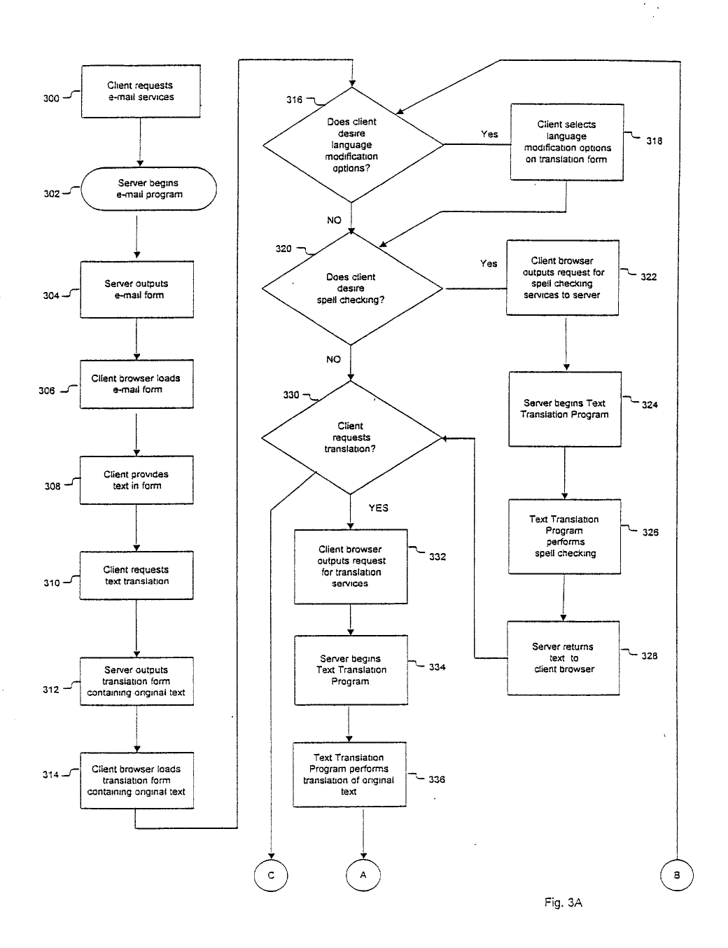

FIG. 2 is a block diagram illustrating a high-level overview of the e-mail translation system in an embodiment according to the present invention. An Intranet 10 may be used to carry out the present invention. As shown in FIG. 2, a computer having a user's browser 2 and a computer having a recipient's browser 4 may connect through the Internet 10 to an e-mail/translation web server 8. The browser may be connected to the Internet 10 via a modem, Ethernet connection, or other communications link. The user's browser 2 and the recipient's browser 4 may be Internet browsing software, such as NETSCAPE NAVIGATOR® (Netscape Communications Corporation) or MICROSOFT INTERNET EXPLORER® (Microsoft Corporation). The e-mail/translation web server 8 may be on a server computer or on a plurality of computers (such as a tier of computers), wherein the server is comprised of a plurality of computers. The e-mail/translation web server 8 provides the functionality of both the e-mail web server 6 and the translation web server 8 as shown in FIG. 1.

The e-mail/translation web server 8 can be implemented in a wide variety of commercially available configurations. In one embodiment, the configuration may be a computer system such as a run on a Microsoft Windows 2000 Server with 1-4 Intel® Pentium III® 800 MHz w/256K L2 cache (Dual Processor Upgradeable) processors; 256 MB of RAM (two 128 MB modules) PC 100 ECC, SDRAM or DIMM memory; 275 watt power supply; integrated 32-bit PCI graphics card w/2 MB DRAM; 9 GB Ultra160 SCSI SCA 10K RPM hard drive; an integrated dual channel SCSI controller; a 3.5″ 1.44 MB diskette drive; a CD-ROM 40×IDE; and a integrated Intel PCI 10/100 Twisted Pair Ethernet network card.

The user's browser 2 and the recipient's browser 4 can reside on a wide range of computer platforms, including personal computers. In the present invention, as many client computers may be used as necessary. Thus, there may be a client computer for each user that desires access to the present invention). Additionally, to protect access to the present invention from unauthorized individuals on the Web, a firewall may be erected, passwords may be required, or data encryption may also be used.

In addition to the Internet 10, which allows for general, public transfer of information, other means of transferring such information exist and are commonly utilized. For example, direct modem connections between two computers, proprietary internal networks within large institutions and organizations, such as a local area network (“LAN”), or the like, are equally available and useful means for accessing catalogued information stored in databases.

A client browser (e.g., the user's browser 2 or the recipient's browser 4) on a computer may be used to make a request for e-mail and translation services to the e-mail/translation web server 8. The client browser passes to the e-mail/translation web server 8 the name of a server program (e.g., the e-mail program) to run along with a set of arguments and values. In one embodiment, this request is encoded in a client web page via a link or form so that the user may access the programs by using a computer mouse. In other embodiments, for example, this request may originate from a JAVA® (Sun Microsystems, Inc.) program and may request that the browser load a new web page, or the request may also be in response to action through a computer mouse by single or multiple clicks.

The request is passed to the e-mail/translation web server 8 and onto the e-mail program using the HTTP web protocol and executed on the server using, for example, the Common Gateway Interface (“CGI”) mechanism. Alternatively, this may be accomplished using other protocols, such as PHP Hypertext Preprocessor (“PHP”) (PHP Development Team), or an Internet Server Application Program Interface (“ISAPI”) (Microsoft Corporation), application such as Active Server Pages (“ASP”) (Microsoft Corporation). Standard web server programs such as the APACHE™ (Apache Software Foundation) web server or MICROSOFT'S INTERNET INFORMATION SERVER® (Microsoft Corporation) can be configured to handle these requests. The server program executes and creates a new web page as output, for example in HTML, EXtensible Markup Language (“XML”), or any other web page format, which replaces the current web page in the client browser. While the web server 8 in the present invention is generally referenced as being a single computer, the present invention may equally work on any system of networked servers.

Alternatively, for example, the client request may originate from an applet, such as a JAVA® program, that runs in the web page. Applets are programs that can run inside web pages. The applet is also able to communicate with the CGI program through web server software. The CGI program, for example, may then use a data format that the applet could readily interpret. Throughout this description of the present invention, anywhere that is described as using JAVA® may alternatively use any applet.

The software used in the present invention may be implemented using any programming languages such as Visual Basic® (Microsoft Corporation) and JAVA Script (Sun Microsystems, Inc.). While the present invention is generally referenced as being used on the Internet, the present invention may equally work on any system of networked computers such as a LAN. Additionally, the client computer may be any workstation, personal computer, server computer, handheld computer, laptop computer, mobile or wireless computing device.

In an embodiment of the e-mail/translation system, if the user wishes to translate an e-mail from one language into another language, the user may employ a simplified process that typically requires less cutting and pasting than in conventional systems. First, after the user displays a web page on the user's browser 2 from the e-mail web server 6, the user writes text in the original language into an e-mail message. Second, the user sends the e-mail message with the original language to the e-mail/translation web server 8 merely by initiating a request from the displayed web page. After a text translation program on the e-mail/translation web server 8 completes the translation, the e-mail/translation web server 8 returns a new web page containing the original text and the translated text to the user's browser 2 for any desired modifications. If the user decides to modify the text in any way, the user can send the text back to the e-mail/translation web server by again initiating a request. Or, the user can accept the translation and the e-mail translation system of the present invention then redisplays on the user's browser 2 the original e-mail message with both the original text and the translated text. The user can then send the e-mail to a recipient by initiating a send request.

During this entire process of the e-mail translation method of the present invention, the user is not required to cut and paste any text from one web page into another. Nor, is the user required to delete text after making modifications to the original text.

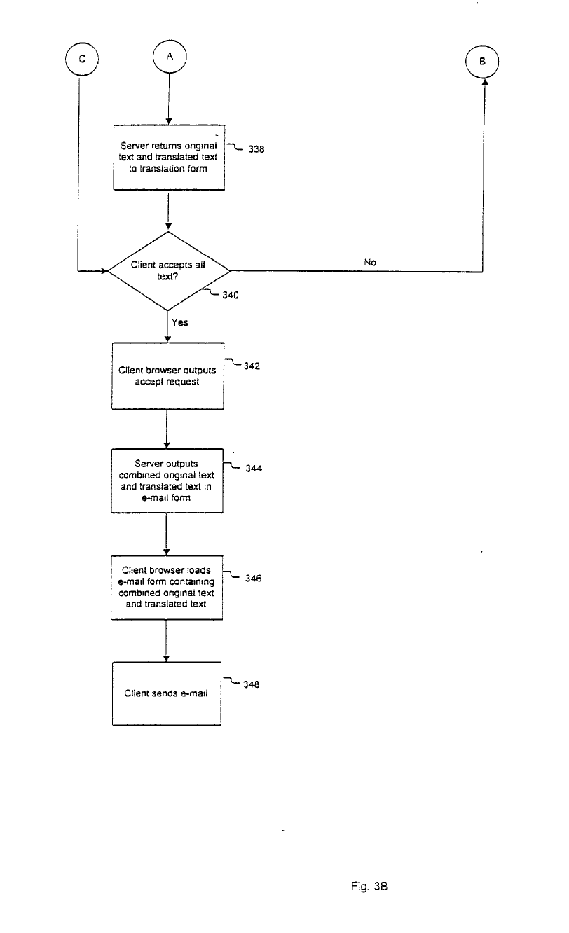

FIGS. 3A & 3B are block diagrams illustrating another embodiment of the present invention. The method begins at 300, when a user requests e-mail services from a web site that offers the e-mail/translation system of the present invention. A user may make this request by sending a HTTP request through the user's browser 2 (shown in FIG. 2) to the e-mail/translation web server 8 (shown in FIG. 2). In response to the user's request, the e-mail/translation web server 8 begins execution of the e-mail/translation program at 302.

At 304, the e-mail/translation web server outputs an e-mail message form using the HTTP protocol. This e-mail message form may be a HTML web page that is loaded onto the user's browser 2 at 306. The e-mail web page may contain a URL of the e-mail/translation web server 8.

The e-mail message form may contain an address options block and a send options block. The address options block and the send options block provide addressing and sending options to the user for the e-mail message. For example, the address options block may include the following windows for inputting of information by the user: “to:” (who the message is addressed to), “subject:” (what the message is about) “cc:” (who is sent a copy of the message in addition to the recipients in the “to:” option) and “bcc:” (who is also sent a copy of the message but who is not listed on the copies sent to the recipients in the “to:” and “cc:” options). The address options block may contain an address book link for linking to an address book database of stored e-mail addresses and a save block that can allow a user to save copies of the e-mail message. The send block may include blocks for sending the message, attaching a file, saving a draft, clearing the e-mail form, as well as selecting signatures for the e-mail message.

At 308, the user enters original text in a certain language into a text window on the e-mail form. This language may be any language such as English, Spanish, French, etc. After entering the original text, the user may translate the text by activating a request for translation on the e-mail form at 310. In response, at 312, the e-mail/translation web server invokes a routine that opens a translation form containing the original text from the e-mail form. In an embodiment, the routine that opens the translation form may be a Javascript® routine.

At 314, the user's browser loads the translation form containing the original text. At 316, the user decides whether to employ any of language options for the translation. In one embodiment, the translation form may contain a direction of translation block that allows the user to specify which language to translate the original text into. For example, the user may select to translate the original text in the French language into the German language. The translation form may also contain various translation modification options. The translation modification options may be tailored to the specific language in use. For example, the user can modify or add to this text by including specific characters from the translation language, such as Á, á, Ñ, ñ, Ü and ü from the Spanish language.

The translation form may also contain other translation modification options such as a gender block, a number of authors block, and formal address block and a proper nouns block. The gender block can allow selection of masculine or feminine language characteristics. The number block can allow singular or plural message authorship characteristics. The address block can provide formal or informal language characteristics and the proper nouns block can allow the option of using proper nouns in the message.

At 318, the user selects any desired language modification options on the translation form. The translation modification options can greatly improve the accuracy and quality of the desired translation.

The translation form may also contain a spell check option for checking the spelling of any inputted text. At 320, the user decides whether to spell check the text. If requested by the user, the user's browser 2 outputs a spell check request to the e-mail/translation web server 8 at 322. The spell check request may be a HTTP request. In response to the user's request, at 324 the e-mail/translation web server 8 initiates the spell check program which is contained in the text translation program or the e-mail application. After completing the spell check at 326, the e-mail/translation program returns corrected (if required due to misspellings) or original text (if no corrections are necessary) to the user's browser 2 at 328.

At 330, the user can request translation services for the e-mail message and at 332 the user's browser 2 outputs a translation request to the e-mail/translation web server 8. The translation request may be a HTTP request. In response to the user's request, at 334 the e-mail/translation web server 8 initiates the text translation program.

In an embodiment, the text translation program is a program known as a data link library (“DLL”). A DLL is an executable program module that performs a specific function. DLLs are not launched directly by users, but rather, are called for by a running application and loaded to perform the function. Examples of translation DLLs include programs such as WordMagic Software ESI Deluxe Translator (WordQuest Interlanguage Systems, Ltd., 12220. Beechnut PMB 2026, Houston, Tex. 77072-4832) and SYSTPAN PROfessional Standard (SYSTRAN Software, Inc., 7855 Fay Avenue, Suite 300, La Jolla, Calif. 92037).

When either a translation request (at 330) or a spell check request (at 320) is initiated by the user, the contents of the translation form are sent to the translation DLL to process the message as desired. The translation DLL may identify certain fields (or “calls”) in the translation form to provide parameters to use in its processing. In an embodiment, these fields may include “editOriginalText” (contains the text to translate); “comboDirectionOfTranslation” (specifies original and desired translation languages such as Russian to Italian, Norwegian to English, etc.); “radioAuthorGender” (specifies masculine or feminine gender); “radioAuthorNumber” (specifies singular or plural authorship); “radioAddress” (specifies formal or informal adressing); “radioProperNouns” (specifies whether to use proper nouns); and “TranslationFile” (specifies a certain text file for output if requested by user, otherwise uses default text file).

At 338, when the translation program is completed, the e-mail/translation web server 8 outputs a translation form that contains both the original text and the translated text. The outputted translation form may be a HTML web page. The e-mail/translation program may use certain “tags” to create the translation form with the text and the language modification options selected by the user. In an embodiment, these tags may include <#Original>” (specifies where to position the original text on the translation form); “<#Translation>” (specifies where to position the translated text on the translation form); “<#AuthorGenderMasculine>” and “<#AuthorGenderFeminine>” (specifies which gender selection was used in the translation) “<#AuthorNumberSingular>” and “<#AuthorNumberPlural>” (specifies whether singular or plural authorship was used in the translation); “<#AddressFormal>” and “<#AddressInformal>” (specifies whether formal or informal addressing was used in the translation); and “<#TranslateProperNouns>” and “<#LiteralProperNouns>” (specifies whether proper nouns were used in the translation).

At 340, the user can again request further language modifications (at 316) and/or spell check (at 320) and/or more translation (at 330) or the original and/or the translated text. The user can also accept the original text and the translated text at 330 when no further language modifications, spell check or translation services are desired. After acceptance by the user, the user's browser 2 outputs an accept request to the e-mail/translation web server 8 at 342. In response the accept request, the e-mail/translation web server 8 combines the original text and the translated text into one file and outputs the file in an e-mail form to the user at 344. Further, if the user (manually through language modification options, spell check or by choice) changed the original text to create “new” original text, the e-mail/translation system automatically replaces the “old” original text with the “new” original text when it combines the text at 344.

At 346, the user's browser displays the e-mail form containing both the original text and the translated text. Finally, at 348, the user may send the e-mail to a recipient's mailbox by activating a send request on the send block. The recipient can then open and read the e-mail.

The e-mail translation system and method of the present invention offers several advantages over the conventional method of translating text. For example, the user is not required to cut and paste text between windows. Therefore, the translation system and method of the present invention does not require use of a second application or second instance of a browser. Moreover, the user can edit the text throughout the entire process and changes to previously translated text result in a re-translation operation.

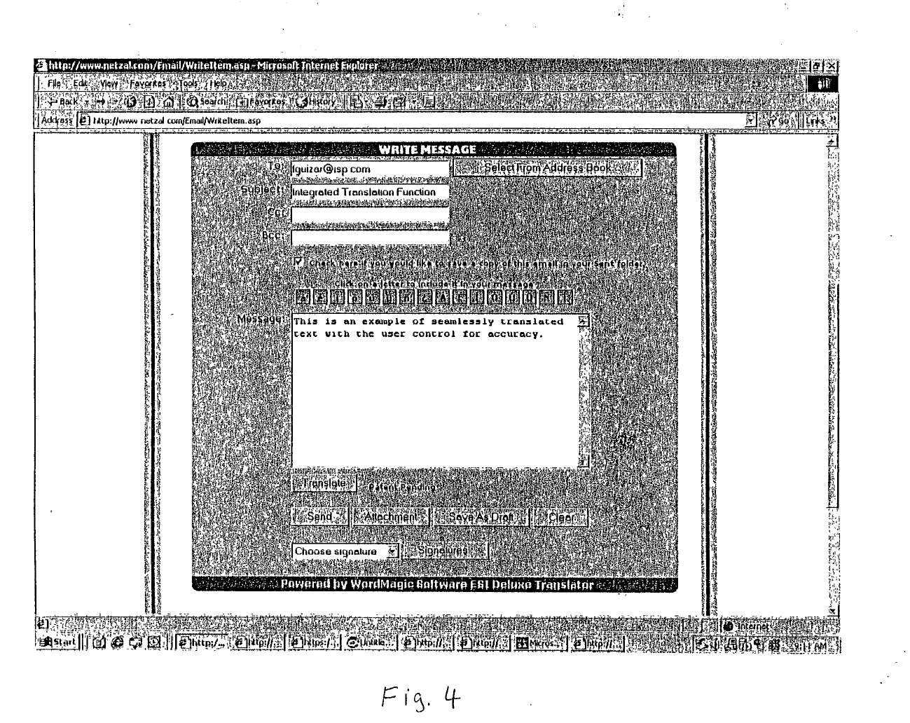

FIGS. 4-8 illustrate images of an e-mail translation system and method in an embodiment according to the present invention.

Referring now to FIG. 4, an e-mail form containing a window for entry of original text by a user, as output from one embodiment of the present invention is shown.

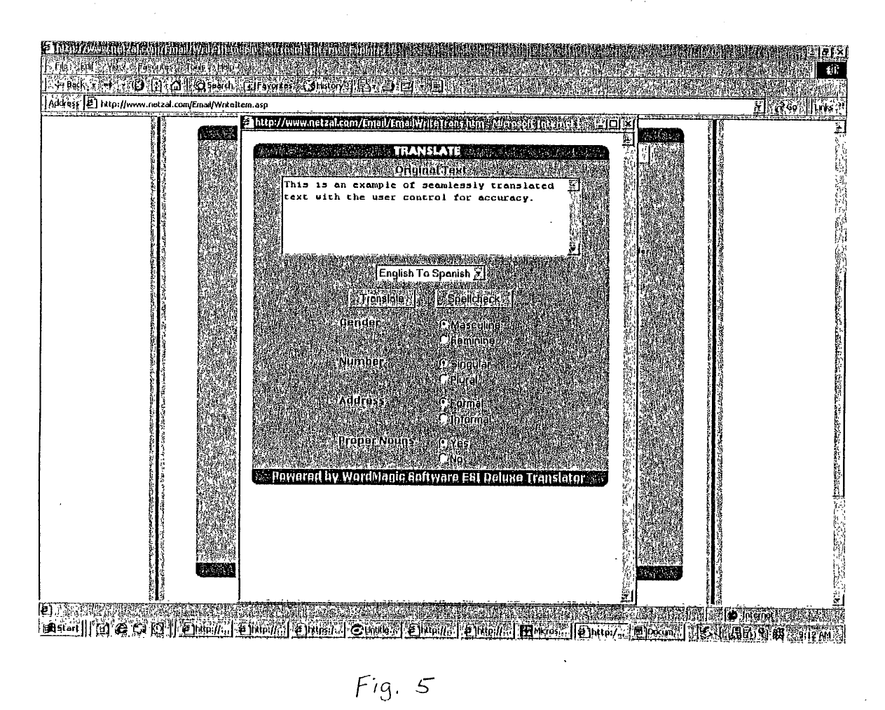

Referring now to FIG. 5, a translation form containing various language modification options, as output from one embodiment of the present invention is shown.

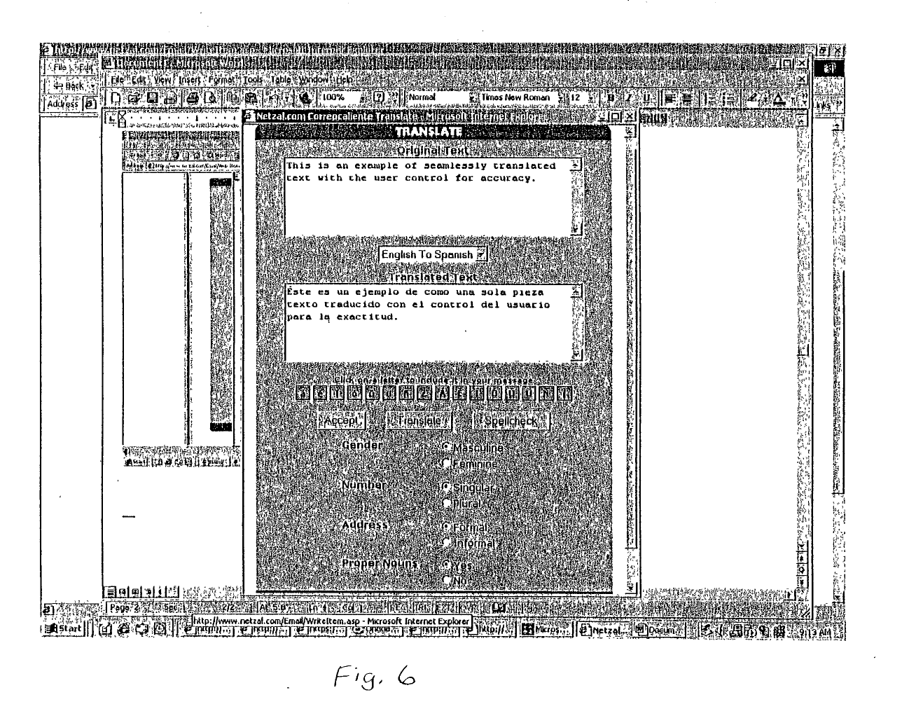

Referring now to FIG. 6, a translation form containing various language modification options, as output from one embodiment of the present invention is shown.

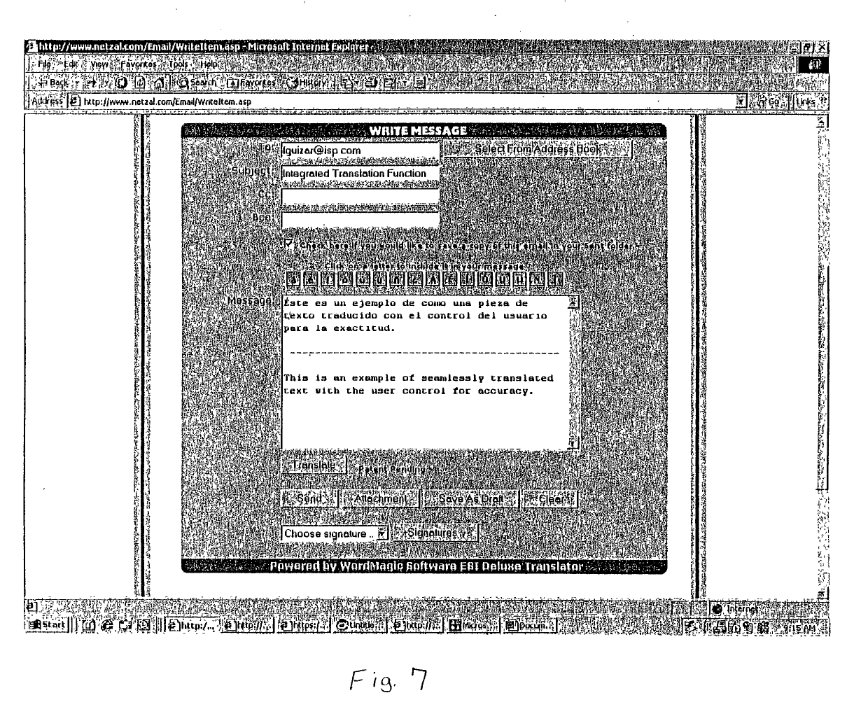

Referring now to FIG. 7, an e-mail form with a window containing both the original text and the translated text, as output from one embodiment of the present invention is shown.

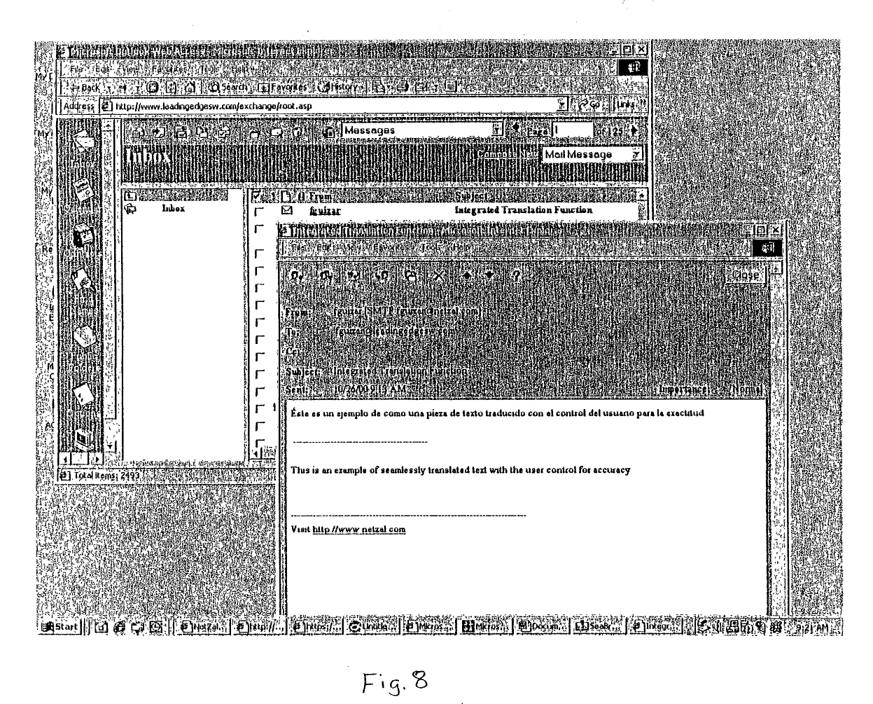

Referring now to FIG. 8, a received e-mail message containing the original text and the translated text, as output from one embodiment of the present invention is shown.

The implementation of the e-mail translation system is illustrated in Appendix A, which is included with this application and is incorporated by reference. Appendix A are two duplicate CD-ROMs (labeled as Copy 1 and Copy 2) containing two files each:

EmailWriteTrans.htm (File size: 4367B, Date created: ______); and

WriteItem.asp (File size: 49 KB, Date Created: ______).

While this application of an e-mail translation system is one embodiment of the present invention, other embodiments are possible. For example, an embodiment can relate to submissions of stories or reviews of books, CDs, events or performances on the Web that require translation services. Another embodiment can be employed in systems relating to descriptions of items and services for sale or barter. Another embodiment can be utilized in systems relating to personal ad descriptions and discussion group postings.

The present invention has been described with respect to particular embodiments thereof, and numerous modifications can be made which are within the scope of the invention as set forth in the claims.

### List of Appendixes

Appendix A: CD-ROM of Source Code for E-mail Translation Program

What is claimed is:

1. A method of translating text in an e-mail message, comprising the steps of:
receiving original text in an original language in the e-mail message;
translating the original text into translated text in a translated language; and
displaying one or both of the original text and translated text in the e-mail message.

2. The method of claim 1, wherein the step of receiving the original text further comprises the step of providing one or more text modification options for selection by a user.

3. The method of claim 2, wherein the one or more text modification options comprise one or more options from the group comprising spell check, special language characteristics, direction of translation, authorship number, formal or informal addressing and use of proper nouns.

4. The method of claim 2, wherein the step of receiving original text further comprises the step of modifying the original text using the one or more text modification options.

5. The method of claim 2, wherein the step of translating the original text further comprises the step of modifying the original text or the translated text.

6. The method of claim 5, wherein the step of translating the original text further comprises the step of re-translating the original text after modifying the original text or the translated text.

7. The method of claim 1, wherein the original language is English and the translated language is Spanish.

8. The method of claim 1, wherein the original language is Spanish and the translated language is English.

9. The method of claim 1, further comprising the step of sending the e-mail message to a recipient.

10. The method of claim 5, wherein the step of modifying the original text or the translated text is accomplished by using the one or more text modification options.

11. A method of translating text in an e-mail message, comprising the steps of:
receiving original text in an original language in the e-mail message;
providing one or more text modification options;
translating the original text into translated text in a translated language;
displaying the original text and translated text; and
modifying the original text or the translated text using the one or more text modification options;
re-translating the original text into translated text in a translated language;
displaying the modified original text and translated text in the e-mail message.

12. The method of claim 11, wherein the one or more text modification options comprise one or more options from the group comprising spell check, special language characteristics, direction of translation, authorship number, formal or informal addressing and use of proper nouns.

13. The method of claim 11, wherein the original language is English and the translated language is Spanish.

14. The method of claim 11, wherein the original language is Spanish and the translated language is English.

15. The method of claim 11, further comprising the step of sending the e-mail message to a recipient.

16. A method of translating text in a web page, comprising the steps of:
displaying the web page;
receiving original text in an original language in the web page;
translating the original text into translated text in a translated language; and
displaying the original text and translated text in the web page.

17. The method of claim 16, wherein the step of displaying the original text further comprises the step of providing one or more text modifications options for selection by a user.

18. The method of claim 17, wherein the one or more text modification options comprise one or more options from the group comprising spell check, special language characteristics, direction of translation, authorship number, formal or informal addressing and use of proper nouns.

19. The method of claim 15, wherein the step of receiving original text further comprises the step of modifying the original text.

20. The method of claim 17, wherein the step of translating the original text further comprises the step of modifying the original text or the translated text.

21. The method of claim 20, wherein the step of translating the original text further comprises the step of re-translating the original text after modifying the original text or the translated text.

22. The method of claim 16, wherein the original language is English and the translated language is Spanish.

23. The method of claim 16, wherein the original language is Spanish and the translated language is English.

24. The method of claim 16, further comprising the step of sending the web page to a recipient.

25. The method of claim 16, wherein the web page is in HTML or XML format.

26. A method of translating text in a web page, comprising the steps of:
displaying the web page;
receiving original text in an original language in the web page;
providing one or more text modification options;
translating the original text into translated text in a translated language;
displaying the original text and translated text; and
modifying the original text or the translated text;
re-translating the original text into translated text in a translated language;
displaying the modified original text and translated text in the web page.

27. The method of claim 26, wherein the one or more text modification options comprise one or more options from the group comprising spell check, special language characteristics, direction of translation, authorship number, formal or informal addressing and use of proper nouns.

28. The method of claim 26, wherein the original language is English and the translated language is Spanish.

29. The method of claim 26, wherein the original language is Spanish and the translated language is English.

30. The method of claim 26, further comprising the step of sending the e-mail message to a recipient.

31. The method of claim 26, wherein the web page is in HTML or XML format.

32. The method of claim 26, wherein the step of modifying the original text or the translated text is accomplished by using the one or more text modification options.

33. A system for translating text in an e-mail message, comprising:
a server for providing the e-mail message;
original text in an original language that is entered into the e-mail message;
a text translation program located on the server for translating the original text into translated text in a translated language;
one or more text modification options displayed on the e-mail message, wherein a user can modify the original text or the translated text using the one or more text modification options; and
wherein the original text and translated text are displayed in the e-mail message.

34. The system of claim 33, wherein the one or more text modification options comprise one or more options from the group including spell check, special language characteristics, direction of translation, authorship number, formal or informal addressing and use of proper nouns.

35. The system of claim 33, wherein the original language is English and the translated language is Spanish.

36. The system of claim 33, wherein the original language is Spanish and the translated language is English.

37. The system of claim 33, wherein the e-mail message including the original text and the translated text is sent to a recipient's mailbox coupled to the server.

38. The system of claim 33, wherein the text translation program comprises a translation data link library.

39. A means for translating text in an e-mail message, comprising:
means for providing the e-mail message and language translation;
a browser coupled to the means for providing the e-mail message and language translation;
means for receiving original text in an original language from the user node;
means for displaying the original text on the browser and providing one or more text modification options;
means for translating the original text into translated text in a translated language;
means for displaying the original text and translated text on the browser; and
wherein one or both of the original text and translated text are displayed in the e-mail message in the means for receiving original text in an original language in response to a request by the user.

40. The means of claim 39, wherein the one or more text modification options comprise one or more options from the group including spell checking, special language characteristics, direction of translation, authorship number, formal or informal addressing and use of proper nouns.

41. The means of claim 39, wherein the original language is English and the translated language is Spanish.

42. The means of claim 39, wherein the original language is Spanish and the translated language is English.

43. The means of claim 39, wherein the e-mail message including the original text and the translated text is sent to a recipient's mailbox coupled to the means for providing the e-mail message and language translation.

44. The means of claim 39, further comprising a second browser coupled to the recipient's mailbox;
wherein the e-mail message containing the original text and translated text is displayed by the second browser.

45. The means of claim 39, wherein the means for translating comprises a translation data link library.

46. A computer system for translating text in an e-mail message, comprising:
a server for providing the e-mail message;
a computer coupled to the server;
original text in an original language that is entered into the e-mail message;
a text translation program located on the server for translating the original text into translated text in a translated language in response to a request by the computer;
one or more text modification options displayed on the e-mail message, wherein a user can modify the original text or the translated text using the one or more text modification options; and
wherein one or both of the original text and translated text are displayed in the e-mail message.

47. The computer system of claim 46, wherein the one or more text modification options comprise one or more options from the group including spell check, special language characteristics, direction of translation, authorship number, formal or informal addressing and use of proper nouns.

48. The computer system of claim 46, wherein the original language is English and the translated language is Spanish.

49. The computer system of claim 46, wherein the original language is Spanish and the translated language is English.

50. The computer system of claim 46, wherein the e-mail message including the one or both of the original text and the translated text is sent to a recipient's mailbox coupled to the server.

51. The computer system of claim 46, further comprising a second computer coupled to the recipient's mailbox;
wherein the e-mail message containing one or both of the original text and translated text is displayed by the computer.

52. The computer system of claim 46, wherein the text translation program comprises a translation data link library.
